(19) United States
(12) Patent Application Publication
(10) Pub. No.: US 2017/0055141 A1
(43) Pub. Date: Feb. 23, 2017

(54) METHOD OF TRANSMITTING AND RECEIVING EMERGENCY PDN CONNECTION-RELATED SIGNAL IN WIRELESS COMMUNICATION SYSTEM AND APPARATUS THEREFOR

(71) Applicant: LG Electronics Inc., Seoul (KR)

(72) Inventors: Laeyoung Kim, Seoul (KR); Jinsook Ryu, Seoul (KR); Hyunsook Kim, Seoul (KR); Myungjune Youn, Seoul (KR)

(21) Appl. No.: 15/244,738

(22) Filed: Aug. 23, 2016

Related U.S. Application Data
(60) Provisional application No. 62/208,799, filed on Aug. 23, 2015.

(51) Int. Cl. H04W 4/22; H04W 8/06; H04W 76/02

(52) U.S. Cl. CPC H04W 4/22; H04W 76/02; H04W 8/06; H04W 80/04

(57) ABSTRACT

A method of transmitting and receiving an emergency PDN connection-related signal, which is transmitted and received by an MME in a wireless communication system, comprising the steps of: receiving a PDN connectivity request message from a UE; determining whether or not an IMS NNI exists between a HPLMN (home public land mobile network) of the UE and a PLMN of the MME and whether or not an anonymous emergency call is permitted; and if the IMS NNI does not exist and the anonymous emergency call is not permitted, transmitting a PDN connectivity reject message to the UE.

This application claims the benefit of the U.S. Provisional Patent Application No. 62/208,799, filed on Aug. 23, 2015, which is hereby incorporated by reference as if fully set forth herein.

### BACKGROUND OF THE INVENTION

Field of the Invention

The following description relates to a wireless communication system, and more particularly, to a method of transmitting and receiving an emergency PDN connection/attach-related signal and an apparatus therefor.

Discussion of the Related Art

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system.

### SUMMARY OF THE INVENTION

Accordingly, the present invention is directed to an apparatus and method thereof that substantially obviate one or more problems due to limitations and disadvantages of the related art.

A technical task of the present invention is to provide a method of transmitting and receiving a signal when a UE roaming a VPLMN generates an emergency PDN connection.

It will be appreciated by persons skilled in the art that the objects that could be achieved with the present invention are not limited to what has been particularly described hereinabove and the above and other objects that the present invention could achieve will be more clearly understood from the following detailed description.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to the present invention, it is able to solve such a problem as latency and the like capable of being occurred when a UE roaming a VPLMN makes a request for an emergency PDN connection.

It will be appreciated by persons skilled in the art that that the effects that can be achieved through the present invention are not limited to what has been particularly described hereinabove and other advantages of the present invention will be more clearly understood from the following detailed description

It is to be understood that both the foregoing general description and the following detailed description of the present invention are exemplary and explanatory and are intended to provide further explanation of the invention as claimed.

To achieve these objects and other advantages and in accordance with the purpose of the invention, as embodied and broadly described herein, a method of transmitting and receiving an emergency PDN connection-related signal, which is transmitted and received by an MME in a wireless communication system, comprising the steps of receiving a PDN connectivity request message from a UE, determining whether or not an IMS NNI exists between a HPLMN (home public land mobile network) of the UE and a PLMN of the MME and whether or not an anonymous emergency call is permitted; and if the IMS NNI does not exist and the anonymous emergency call is not permitted, transmitting a PDN connectivity reject message to the UE.

The request type of the PDN connectivity request message is configured as emergency.

The UE is roaming a VPLMN (visited PLMN).

Whether or not the IMS NNI exists is checked by a local configuration set to the MME.

Whether or not the anonymous emergency call is permitted is checked by at least one selected from the group consisting of a local regulation, a local configuration, and an operator policy.

The PDN connectivity reject message comprises one selected from the group consisting of a reject cause, information indicating to attempt a CS emergency call, information indicating to perform CS attach, information indicating to perform combined attach, information indicating to perform combined TAU, information indicating not to attempt an IMS emergency call, information indicating not to establish an emergency PDN, and information indicating not to attempt IMS emergency registration.

In another aspect of the present invention, a method of transmitting and receiving an emergency attach-related signal, which is transmitted and received by an MME in a wireless communication system, comprising the steps of receiving an attach request message from a UE, determining whether or not an IMS NNI exists between a HPLMN (home public land mobile network) of the UE and a PLMN of the MME and whether or not an anonymous emergency call is permitted; and if the IMS NNI does not exist and the anonymous emergency call is not permitted, transmitting an attach reject message to the UE.

A request type of the attach request message is configured as emergency.

The UE is roaming a VPLMN (visited PLMN).

Whether or not the IMS NNI exists is checked by a local configuration set to the MME.

Whether or not the anonymous emergency call is permitted is checked by at least one selected from the group consisting of a local regulation, a local configuration, and an operator policy.

The attach reject message comprises one selected from the group consisting of a reject cause, information indicating to attempt a CS emergency call, information indicating to perform CS attach, information indicating to perform combined attach, information indicating not to attempt an IMS emergency call, information indicating not to establish an emergency PDN, and information indicating not to attempt IMS emergency registration.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic diagram showing the structure of an evolved packet system (EPS) including an evolved packet core (EPC);

FIG. 2 is a diagram exemplarily illustrating architectures of a typical E-UTRAN and EPC;

FIG. 3 is a diagram exemplarily illustrating the structure of a radio interface protocol in a control plane;

FIG. 4 is a diagram exemplarily illustrating the structure of a radio interface protocol in a user plane;

FIG. 5 is a flowchart illustrating a random access procedure;

FIG. 6 illustrates a connection procedure in a radio resource control (RRC) layer;

FIG. 7 is a diagram for explaining a 3GPP access structure;

FIGS. 8 to 10 are diagrams for explaining a legacy technology and a problem;

FIGS. 11 to 13 are diagrams for explaining embodiments of the present invention;

FIG. 14 is a diagram for explaining a device configuration of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

Specific terms used for the embodiments of the present invention are provided to help in understanding of the present invention. These specific terms may be replaced with other terms within the scope and spirit of the present invention.

In some instances, to prevent the concept of the present invention from being ambiguous, structures and apparatuses of the known art will be omitted, or will be shown in block diagram form based on main functions of each structure and apparatus. In addition, wherever possible, like reference numerals denote the same parts throughout the drawings and the specification.

The embodiments of the present invention can be supported by standard documents disclosed for at least one of wireless access systems including Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by these specifications. Further, all terms as set forth herein can be explained by the standard specifications.

Techniques described herein can be used in various wireless access systems. For clarity, the present disclosure focuses on 3GPP LTE and LTE-A systems. However, the technical features of the present invention are not limited thereto.

Terms used in the following description are defined as follows.

UMTS (Universal Mobile Telecommunication System): 3^{rd} generation mobile communication technology based on a Global System for Mobile Communication (GSM) developed by 3GPP.

EPS (Evolved Packet System): Network system including an Evolved Packet Core (EPC) which is a Packet Switched (PS) core network based on Internet Protocol (IP) and an access network such as LTE/UTRAN, which is evolved from UMTS.

NodeB: Base station of a GERAN/UTRAN, which is installed outdoors and has a coverage corresponding to a macro cell.

eNodeB: Base station of E-UTRAN, which is installed outdoors and has a coverage corresponding to a macro cell.

UE (User Equipment): UE can also be referred to as a terminal, a Mobile Equipment (ME), a Mobile Station (MS) or the like. In addition, the UE can be a portable device such as a laptop computer, a mobile phone, a Personal Digital Assistant (PDA), a smartphone or a multimedia device, or a non-portable device such as a Personal Computer (PC) or a vehicle-mounted device. In MTC, the term “UE” or “terminal” may refer to an MTC device.

HNB (Home NodeB): Base station of a UMTS network, which is installed outdoors and has a coverage corresponding to a macro cell.

HeNB: Base station of an EPS network, which is installed outdoors and has a coverage corresponding to a macro cell.

MME (Mobility Management Entity): Network node of an EPS network, which performs Mobility Management (MM) and Session Management (SM).

PDN-GW (Packet Data Network-Gateway)/P-GW: Network node of an EPS network, which performs UE IP address allocation, packet screening and filtering, charging data collection, etc.

SGW (Serving Gateway): Network node of an EPS network, which performs mobility anchoring, packet routing, idle mode packet buffering, a function of triggering an MME to page a UE, etc.

NAS (Non-Access Stratum): Upper stratum of a control plane between a UE and an MME, which is a functional layer for exchanging signaling and traffic messages between a UE and a core network in an LTE/UMTS protocol stack. Major functions thereof are to support UE mobility and to support a session management procedure for establishing and maintaining an IP connection between a UE and a PDN GW.

PDN (Packet Data Network): Network on which a server supporting a specific service (e.g., MMS (Multimedia Messaging Service) server, WAP (Wireless Application Protocol) server or the like) is located.

PDN connection: Logical connection between a UE and a PDN, represented by a single IP address (e.g., single IPv4 address and/or single IPv6 prefix).

RAN (Radio Access Network): Unit including a NodeB, an eNodeB and a Radio Network Controller (RNC) for controlling the NodeB and the eNodeB in a 3 GPP network, which is present between UEs and provides a connection to a core network.

HLR (Home Location Register)/HSS (Home Subscriber Server): Database having subscriber information in a 3GPP network. The HSS can perform functions such as configuration storage, identity management and user state storage.

PLMN (Public Land Mobile Network): Network configured for the purpose of providing mobile communication services to individuals. This network can be configured per operator.

Proximity Service (ProSe Service or Proximity based Service): A service enabling discovery between devices physically close to each other, direct communication between the devices, communication between the devices via a base station or a third device. In this case, user plane data is exchanged through a direct data path rather over a 3GPP core network (e.g., EPC).

ProSe communication: Communication between two or more ProSe-enabled UEs through a ProSe communication path. Unless stated otherwise, ProSe communication may refer to one of ProSe E-UTRA communication, ProSe-assisted WLAN direct communication between two UEs, ProSe group communication and ProSe broadcast communication.

ProSe E-UTRA communication: ProSe communication using an E-UTRA communication path.

ProSe-assisted WLAN direct communication: ProSe communication through a direct communication path.

ProSe communication path: A communication path supporting ProSe communication. The ProSe E-UTRA communication path may be established between ProSe-enabled UEs using E-UTRA or through a local eNB. The ProSe-assisted WLAN direct communication path may be established directly between ProSe-enabled UEs using WLAN.

EPC path (or infrastructure data path): A user plane communication path through EPC

ProSe discovery: A procedure of identifying/checking a nearby ProSe-enabled UE using E-UTRA

ProSe Group Communication: One-to-many ProSe communication between two or more ProSe-enabled UEs close to each other using a common communication path.

ProSe UE-to-Network Relay: A ProSe-enabled public safety UE serving as a relay between a ProSe-enabled network which uses E-UTRA and a ProSe-enabled public safety UE

ProSe UE-to-UE Relay: A ProSe-enabled public safety UE serving as a ProSe communication relay between two or more ProSe-enabled public safety UEs.

Remote UE: A ProSe-enabled public safety UE which does not receive a service through E-UTRAN but is connected to an EPC network through the ProSe UE-to-Network Relay when operating as a UE-to-Network Relay. Namely, The ProSe-enabled public safety UE is provided with PDN connection. When a UE-to-UE Relay operates, the ProSe-enabled public safety UE communicates with another ProSe-enabled public safety UE via the ProSe UE-to-UE Relay.

ProSe-enabled Network: ProSe discovery, A network supporting ProSe communication and/or ProSe-assisted WLAN direct communication. Hereinafter, the ProSe-enabled Network will be simply referred to as a network.

ProSe-enabled UE: A UE supporting ProSe discovery, ProSe communication and/or ProSe-assisted WLAN direct communication. Hereinafter, the ProSe-enabled UE and ProSe-enabled Public Safety UE will be simply referred to as UEs.

Proximity: Satisfying a proximity determination criterion defined for discovery and communication, respectively.

VoLTE(Voice over LTE): Providing PS(Packet Switched) basedvoice (video) service in E-UTRAN by using IMS.

Evolved Packet Core (EPC)

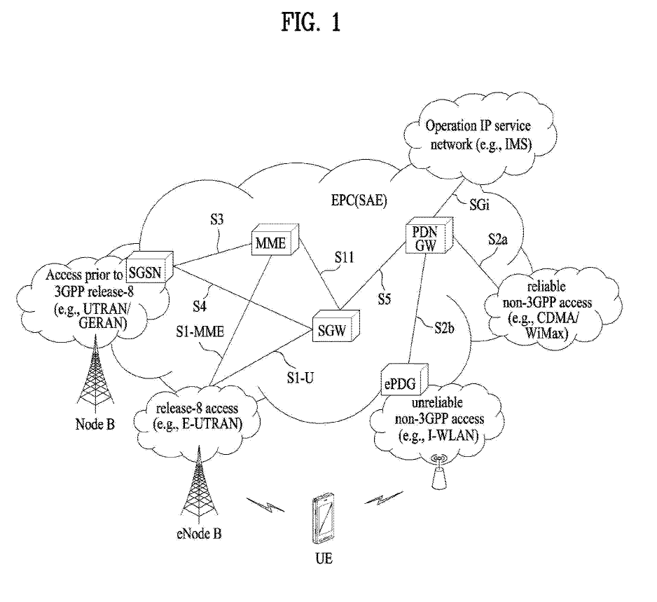

FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, In 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WLAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

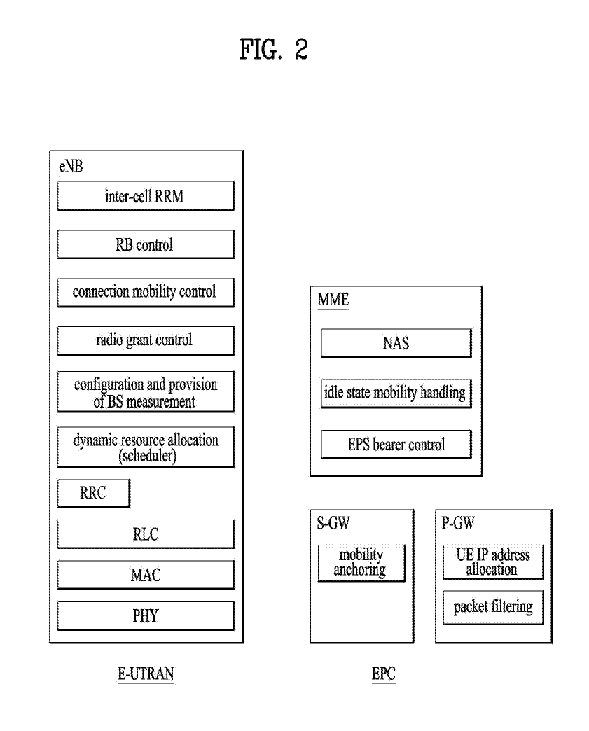

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

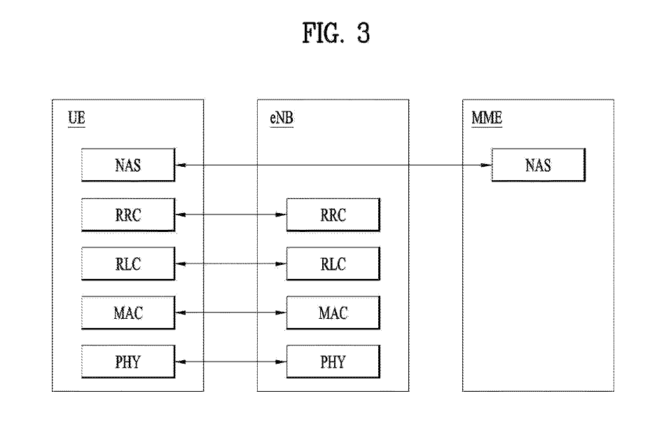

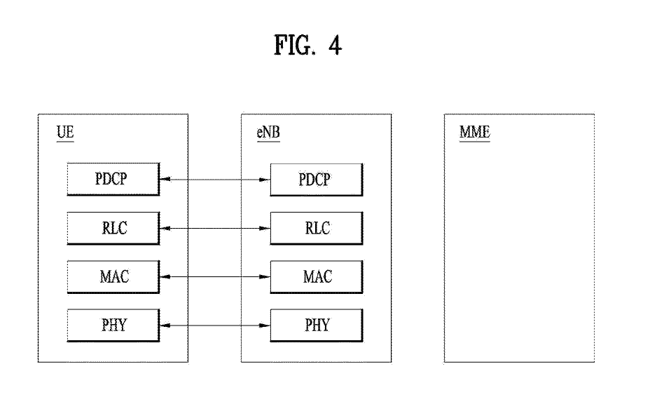

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel Data is transferred between the physical layer and the MAC layer through the transport channel Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of symbols in the time domain and a plurality of subcarriers. One subframe consists of a plurality of resource blocks. One resource block consists of a plurality of symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDSCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers.

First, the MAC layer in the second layer serves to map various logical channels to various transport channels and also serves to map various logical channels to one transport channel The MAC layer is connected with an RLC layer, which is a higher layer, through a logical channel The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LTE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The eSM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

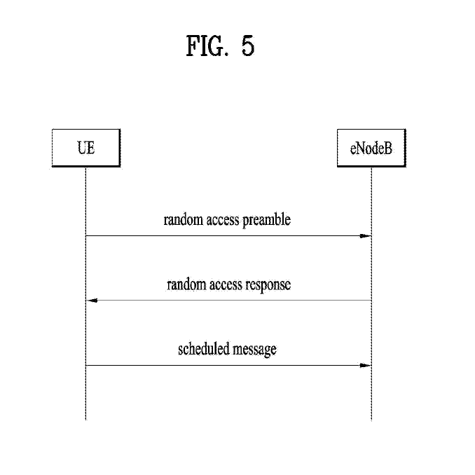

FIG. 5 is a flowchart illustrating a random access procedure in 3GPP LTE.

The random access procedure is used for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH.

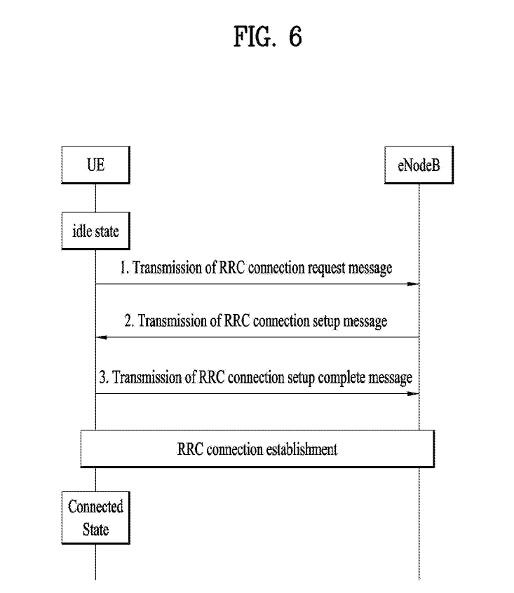

FIG. 6 illustrates a connection procedure in a radio resource control (RRC) layer.

As shown in FIG. 6, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC idle state.

A UE in the Connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, does the UE establish RRC connection with the RRC layer of the eNodeB through the RRC connection procedure and then transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 6.

1) When the UE in the idle state desires to establish RRC connection for reasons such as an attempt to make a call, a data transmission attempt, or a response of the eNodeB to paging, the UE transmits an RRC connection request message to the eNodeB first.

2) Upon receiving the RRC connection request message from the UE, the ENB accepts the RRC connection request of the UE when the radio resources are sufficient, and then transmits an RRC connection setup message, which is a response message, to the UE.

3) Upon receiving the RRC connection setup message, the UE transmits an RRC connection setup complete message to the eNodeB. Only when the UE successfully transmits the RRC connection setup message, does the UE establish RRC connection with the eNodeB and transition to the RRC connected mode.

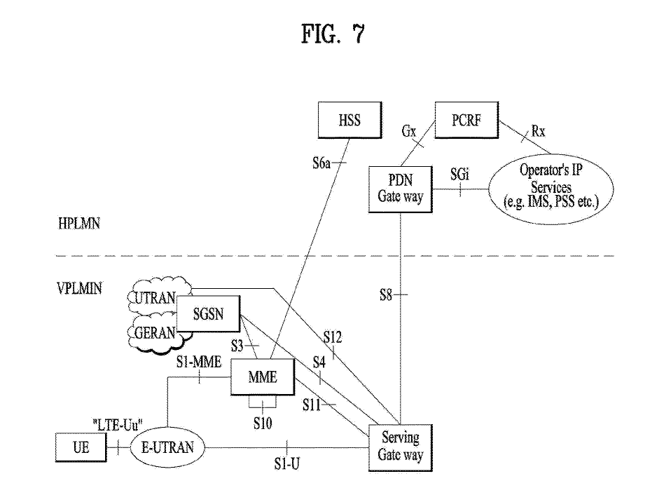

FIG. 7 shows architecture for providing service when roaming UE (UE in a visited PLMN) accesses mobile communication network via 3GPP access (E-UTRAN, UTRAN, GERAN). Especially, FIG. 7 shows architecture about home routed traffic in which service is provided by not P-GW in visited PLMN but P-GW in home PLMN.

PDN Connection Establishment and IMS Registration

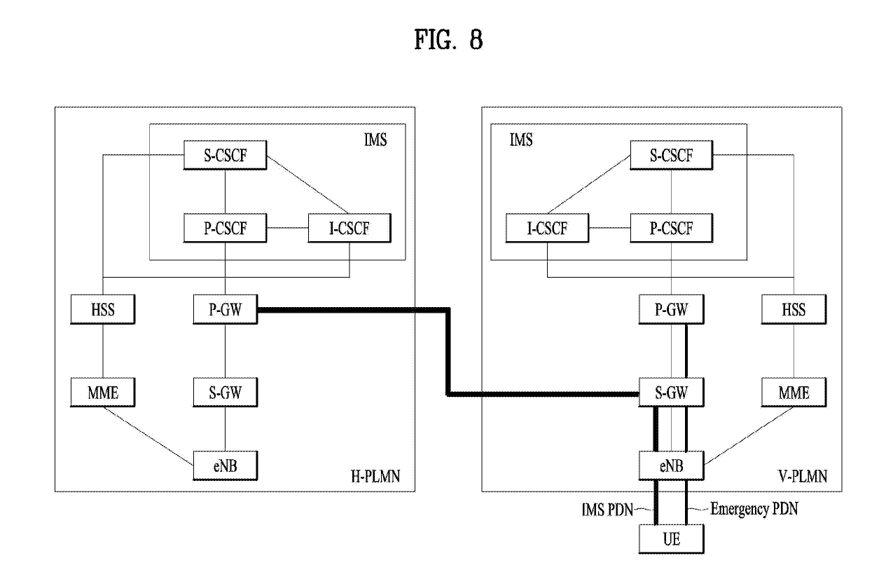

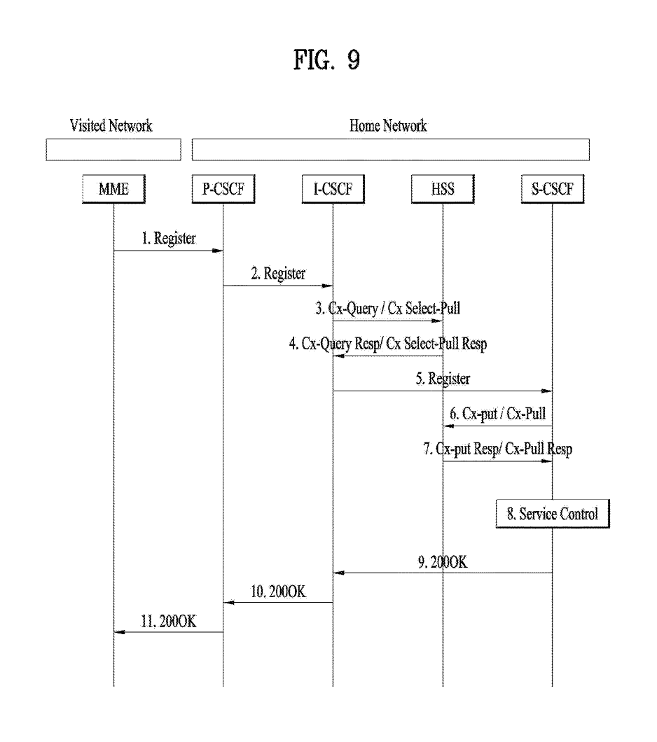

FIG. 8 shows architecture for establishing a PDN connection in a home routed roaming situation according to a legacy technology. A UE generates an IMS PDN via a P-GW of an HPLMN by passing through an S-GW of a VPLMN.

In this case, the IMS PDN may correspond to a PDN for an IMS service, a PDN of a well-known IMS APN, a PDN for a voice-over LTE service, and the like.

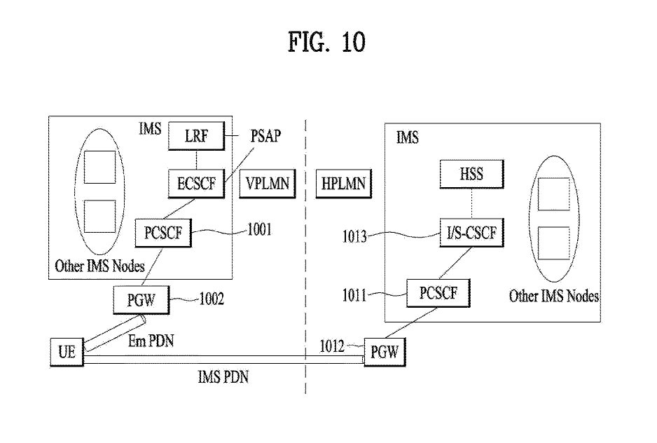

In order for a UE to initiate an IMS emergency call, it is necessary to newly establish an emergency PDN. In case of the emergency PDN, the emergency PDN can be processed by a method different from the aforementioned description. More specifically, if a UE is located at a VPLMN, the emergency PDN is established via a P-GW of the VPLMN. In particular, as shown in FIG. 8, the UE has the emergency PDN connection via an eNB, the S-GW, and a P-GW of the VPLMN. This type of scheme is referred to as an LBO (local BreakOut) scheme. This is because an emergency service should be handled via a VPLMN network due to a property of an emergency structure. Although the emergency PDN is established, the UE should perform IMS emergency registration via the emergency PDN before an emergency call is initiated. To this end, as shown in FIG. 10, it is necessary for the UE to transmit a SIP REGISTER message to an S-CSCF 1013 of HPLMN. In this case, since the emergency PDN is generated (EM PDN) via the P-GW 1002 of the VPLMN, a problem may occur. In particular, if an NNI (network to network interface) does not exist between an HPLMN IMS network and a VPLMN IMS network, it is unable to deliver the SIP REGISTER message from the P-CSCF 1001 belonging to the VPLMN IMS network to the HPLMN IMS network. Hence, the UE fails to perform the IMS emergency registration and a problem of failing to receive an emergency service may occur.

Although the UE fails to perform the IMS emergency registration, the UE may initiate an anonymous emergency call. However, the anonymous emergency call may be limitative. For example, in a PLMN incapable of processing the anonymous emergency call for an unauthenticated UE due to a local regulation, it is unable to receive an emergency service. In this case, there exists not only a problem of failing to receive an emergency service but also a problem of latency. More specifically, the UE is able to know that an IMS emergency call has failed only when a procedure of establishing the emergency PDN, a procedure of the IMS emergency registration, and an anonymous emergency call attempt are all went through. In case of performing all of the aforementioned procedures, it takes considerable amount of time and it does not accord with a purpose of an emergency call that handles an emergency situation. Hence, in embodiments of the present invention described in the following, a method of transmitting and receiving an emergency PDN connection/attach-related signal and an apparatus therefor are explained.

### Embodiment 1—Method of Transmitting and Receiving Emergency PDN Connection-Related Signal

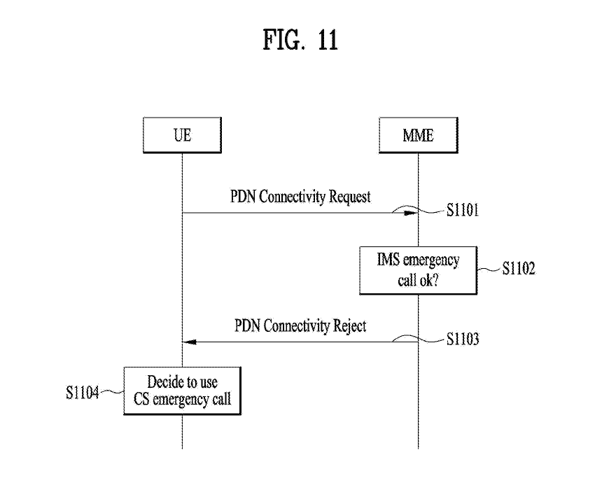

Referring to FIG. 11, an MME according to embodiment of the present invention receives a PDN connectivity request message from a UE roaming a VPLMN [S1101].

The MME determines whether or not an IMS emergency call is permitted [S1102]. Specifically, the MME determines whether or not an IMS NNI exists between a HPLMN of the UE and a PLMN of the MME and whether or not an anonymous emergency call is permitted. It is able to check whether or not the IMS NNI exists via a local configuration set to the MME. And, it is able to check whether or not the anonymous emergency call is permitted via at least one selected from the group consisting of a local regulation, a local configuration, and an operator policy. When the determination is made, it may also be able to consider whether or not a UE is capable of performing CS (circuit switching), whether or not a UE is able to perform a CS emergency call, whether or not a network supports a CS emergency call, and the like. It is able to check whether or not a UE is capable of performing the CS based on information obtained from the UE, information obtained from an eNB, subscriber information, information on whether or not it is attached to the CS of the UE, and the like. It is able to check whether or not a UE is able to perform a CS emergency call based on information obtained from the UE, information obtained from an eNB, subscriber information, information on whether or not it is attached to the CS of the UE, and the like. It is able to check whether or not a network supports a CS emergency call based on a local configuration set to the MME, an operator policy, and the like.

If an IMS NNI does not exist and an anonymous emergency call is not permitted, a PDN connectivity reject message is transmitted to the UE [S1103]. The PDN connectivity reject message can include at least one selected from the group consisting of a reject cause (in this case, the reject cause may include various causes such that establishment of an emergency PDN is failed, emergency PDN support is impossible, IMS emergency call/service support is impossible, IMS emergency registration support is impossible, IMS NNI does not exist, and the like), information indicating to attempt a CS emergency call, information indicating to perform CS attach, information indicating to perform combined attach, information indicating to perform combined TAU, information indicating not to attempt an IMS emergency call, information indicating not to attempt to establish an emergency PDN, and information indicating not to attempt IMS emergency registration.

Having received the PDN connectivity reject message from the MME, the UE performs at least one or more operations described in the following. i) If attach is not performed on a CS, the UE performs CS attach. In this case, the CS attach may correspond to combined attach, combined TAU or CS attach (i.e., IMSI attach). ii) The UE initiates a CS emergency call. The CS emergency call may correspond to a CSFB emergency call or a CS emergency call rather that a CSFB (direct to a CS network).

Such a problem of a legacy technology as latency and the like can be solved by the aforementioned configuration. Moe specifically, as mentioned in the foregoing description, if an IMS NNI does not exist between a HPLMN of a UE and a PLMN of an MME and an anonymous emergency call is not permitted, since time delay is experienced as much as time necessary for establishing an emergency PDN, time for performing an IMS emergency registration, and time for performing an anonymous emergency call attempt procedure, it may be able to reject an emergency PDN connection request at first. In this case, since the UE is able to receive a service via a CS emergency call [S1104], it may be able to achieve all purposes including latency problem resolution and emergency call service provision.

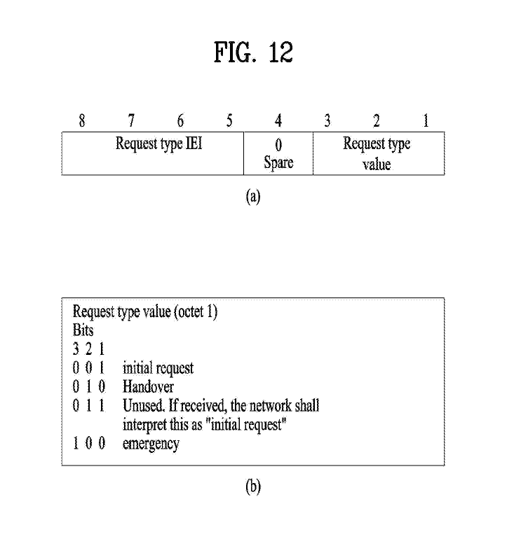

Meanwhile, the PDN connectivity request message can include information elements shown in Table 2 in the following. In particular, a request type can be configured as emergency. Specifically, a request type information element may be identical to an example shown in FIG. 12(a). In this case, it may use a request type value shown in FIG. 12(b). Hence, the PDN connectivity request message can include a request type information element of which a request type value is set to 100. For further details, contents of TS 24.301 and TS 24.008 will be subjected.

TABLE 2

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction identity | Procedure transaction | M | V | 1 |
| | | identity | | | |
| | | 9.4 | | | |
| | PDN connectivity request | Message type | M | V | 1 |
| | message identity | 9.8 | | | |
| | Request type | Request type | M | V | ½ |
| | | 9.9.4.14 | | | |
| | PDN type | PDN type | M | V | ½ |
| | | 9.9.4.10 | | | |
| D- | ESM information transfer flag | ESM information transfer | O | TV | 1 |
| | | flag | | | |
| | | 9.9.4.5 | | | |
| 28 | Access point name | Access point name | O | TLV | 3-102 |
| | | 9.9.4.1 | | | |
| 27 | Protocol configuration options | Protocol configuration | O | TLV | 3-253 |
| | | options | | | |
| | | 9.9.4.11 | | | |
| C- | Device properties | Device properties | O | TV | 1 |
| | | 9.9.2.0A | | | |
| 33 | NBIFOM container | NBIFOM container | O | TLV | 3-257 |
| | | 9.9.4.19 | | | |
| 66 | Header compression | Header compression | O | TLV | 6-257 |
| | configuration | configuration | | | |
| | | 9.9.4.22 | | | |
| 7B | Extended protocol | Extended protocol | O | TLV-E | 4-65538 |
| | configuration options | configuration options | | | |
| | | 9.9.4.26 | | | |

### Embodiment 2—Method of Transmitting and Receiving Emergency Attach-Related Signal

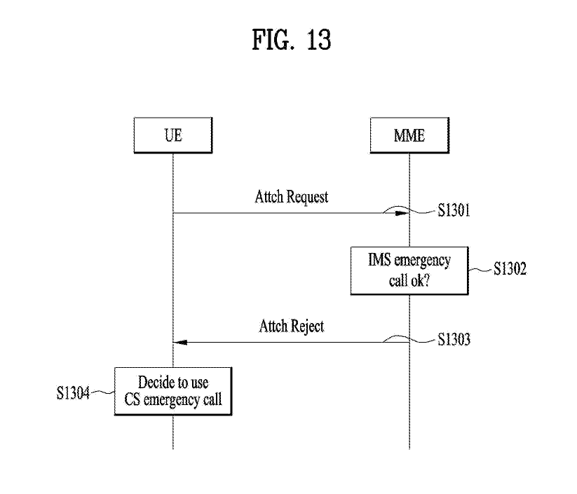

The embodiment 2 relates to a case that a UE roaming a VPLMN performs attach. Referring to FIG. 13, an MME can receive an attach request message from the UE [S1301].

The MME determines whether or not an IMS emergency call is permitted [S1302]. Specifically, the MME determines whether or not an IMS NNI exists between a HPLMN of the UE and a PLMN of the MME and whether or not an anonymous emergency call is permitted. It is able to check whether or not the IMS NNI exists via a local configuration set to the MME. And, it is able to check whether or not the anonymous emergency call is permitted via at least one selected from the group consisting of a local regulation, a local configuration, and an operator policy. When the determination is made, it may also be able to consider whether or not a UE is capable of performing CS (circuit switching), whether or not a UE is able to perform a CS emergency call, whether or not a network supports a CS emergency call, and the like. It is able to check whether or not a UE is capable of performing the CS based on information obtained from the UE, information obtained from an eNB, subscriber information, information on whether or not the UE makes a CS attach request (or a combined attach request), and the like. It is able to check whether or not a UE is able to perform a CS emergency call based on information obtained from the UE, information obtained from an eNB, subscriber information, information on whether or not the UE makes a CS attach request (or a combined attach request), and the like. It is able to check whether or not a network supports a CS emergency call based on a local configuration set to the MME, an operator policy, and the like.

If an IMS NNI does not exist and an anonymous emergency call is not permitted, an attach reject message is transmitted to the UE [S1303]. The attach reject message can include at least one selected from the group consisting of a reject cause (in this case, the reject cause may include various causes such as emergency attach is failed, emergency attach support is impossible, establishment of an emergency PDN is failed, IMS emergency call/service support is impossible, IMS emergency registration support is impossible, IMS NNI does not exist, and the like), information indicating to attempt a CS emergency call, information indicating to perform CS attach, information indicating to perform combined attach, information indicating not to attempt an IMS emergency call, information indicating not to attempt to establish an emergency PDN, and information indicating not to attempt IMS emergency registration.

Having received the attach reject message from the MME, the UE performs at least one or more operations described in the following. i) If attach is not performed on a CS, the UE performs CS attach. In this case, the CS attach may correspond to combined attach, combined TAU or CS attach (i.e., IMSI attach). ii) The UE initiates a CS emergency call. The CS emergency call may correspond to a CSFB emergency call or a CS emergency call rather than a CSFB (direct to a CS network).

Meanwhile, a request type of the Attach request message may be configured as emergency. For further details, contents of TS 24.301 and TS 24.008 will be subjected.

In relation to the aforementioned contents, for details on an IMS emergency session, it may refer to 3GPP TR 23.749 to solve issues to be solved in relation to 3GPP TS 23.167, S8 Home routing Architecture for VoLTE and it is included in the contents of the present invention.

Aforementioned embodiment, it assumed that IMS NNI between does not exist VPLMN in which UE is roaming and HPLMN of UE, but aforementioned embodiment can be applied to with IMS NNI case.

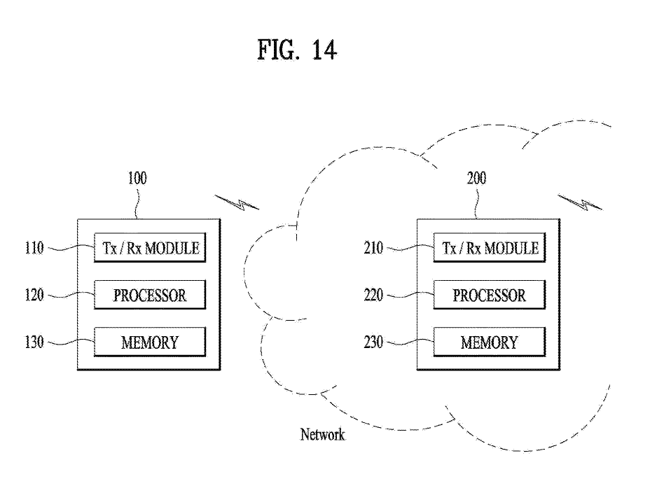

FIG. 14 illustrates configurations of a UE and a network node according to an embodiment of the present invention.

Referring to FIG. 14, a UE 100 according to the present invention may include a transceiver 110, a processor 120 and a memory 130. The transceiver 110 may be configured to transmit signals, data and information to an external device and to receive signals, data and information from the external device. The UE 100 may be connected to the external device in a wired or wireless manner The processor 120 may control the overall operation of the UE 100 and may be configured to process information transmitted/received between the UE 100 and the external device. In addition, the processor 120 may be configured to perform UE operation proposed by the present invention. The memory 130 may store processed information for a predetermined time and may be replaced by a component such as a buffer (not shown).

Referring to FIG. 14, a network node 200 according to the present invention may include a transceiver 210, a processor 220 and a memory 230. The transceiver 210 may be configured to transmit signals, data and information to an external device and to receive signals, data and information from the external device. The network node 200 may be connected to the external device in a wired or wireless manner The processor 220 may control the overall operation of the network node 200 and may be configured to process information transmitted/received between the network node 200 and the external device. In addition, the processor 220 may be configured to perform network node operation proposed by the present invention. The memory 230 may store processed information for a predetermined time and may be replaced by a component such as a buffer (not shown).

The aforementioned UE 100 and network node 200 may be implemented such that the above-described various embodiments of the present invention are independently applied or two or more thereof are simultaneously applied, and description of redundant parts is omitted for clarity.

The embodiments of the present invention may be achieved by various means, for example, hardware, firmware, software, or a combination thereof. In a hardware configuration, the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method of transmitting and receiving an emergency PDN connection-related signal, which is transmitted and received by an MME in a wireless communication system, comprising the steps of:
receiving a PDN connectivity request message from a UE;
determining whether or not an IMS NNI exists between a HPLMN (home public land mobile network) of the UE and a PLMN of the MME and whether or not an anonymous emergency call is permitted; and
if the IMS NNI does not exist and the anonymous emergency call is not permitted, transmitting a PDN connectivity reject message to the UE.

2. The method of claim 1, wherein a request type of the PDN connectivity request message is configured as emergency.

3. The method of claim 1, wherein the UE is roaming a VPLMN (visited PLMN).

4. The method of claim 1, wherein whether or not the IMS NNI exists is checked by a local configuration set to the MME.

5. The method of claim 1, whether or not the anonymous emergency call is permitted is checked by at least one selected from the group consisting of a local regulation, a local configuration, and an operator policy.

6. The method of claim 1, wherein the PDN connectivity reject message comprises one selected from the group consisting of a reject cause, information indicating to attempt a CS emergency call, information indicating to perform CS attach, information indicating to perform combined attach, information indicating to perform combined TAU, information indicating not to attempt an IMS emergency call, information indicating not to establish an emergency PDN, and information indicating not to attempt IMS emergency registration.

7. A method of transmitting and receiving an emergency attach-related signal, which is transmitted and received by an MME in a wireless communication system, comprising the steps of:
receiving an attach request message from a UE;
determining whether or not an IMS NNI exists between a HPLMN (home public land mobile network) of the UE and a PLMN of the MME and whether or not an anonymous emergency call is permitted; and
if the IMS NNI does not exist and the anonymous emergency call is not permitted, transmitting an attach reject message to the UE.

8. The method of claim 7, wherein a request type of the attach request message is configured as emergency.

9. The method of claim 7, wherein the UE is roaming a VPLMN (visited PLMN).

10. The method of claim 7, wherein whether or not the IMS NNI exists is checked by a local configuration set to the MME.

11. The method of claim 7, whether or not the anonymous emergency call is permitted is checked by at least one selected from the group consisting of a local regulation, a local configuration, and an operator policy.

12. The method of claim 7, wherein the attach reject message comprises one selected from the group consisting of a reject cause, information indicating to attempt a CS emergency call, information indicating to perform CS attach, information indicating to perform combined attach, information indicating not to attempt an IMS emergency call, information indicating not to establish an emergency PDN, and information indicating not to attempt IMS emergency registration.
